(19) United States
(12) Patent Application Publication
(10) Pub. No.: US 2021/0174402 A1
(43) Pub. Date: Jun. 10, 2021

(54) SYSTEM FOR FACILITATING BENEFACTION

(71) Applicant: Wells Fargo Bank, N.A., San Francisco, CA (US)

(72) Inventors: Wayne Barakat, Novato, CA (US); Pankaj Parekh, San Francisco, CA (US); Kristine Ing Kushner, Orinda, CA (US); Wairnola M. Rhodriquez, San Francisco, CA (US); Laura M. Fontana, San Francisco, CA (US)

(21) Appl. No.: 15/367,663

(22) Filed: Dec. 2, 2016

(51) Int. Cl. G06Q 30/02; G06Q 20/40

(52) U.S. Cl. CPC G06Q 30/0279; G06Q 20/405

(57) ABSTRACT

A system for facilitating benefaction that identifies donation opportunities by monitoring and learning from users' behavior and suggesting donations based on the behavior of potential benefactors and potential beneficiaries. In certain aspects, the system cross-references donation conditions of one system user with donation conditions of one or more other system users to identify donation triggering events corresponding to donation opportunities.

### BACKGROUND

There is an age old practice of giving goods, services, or money to others to reward past actions, to incentivize future actions, and/or out of simple benevolence, e.g., to provide for a recipient in need or to a recipient whose means are less than those of the giver, or to simply “pay-it-forward” to a stranger in order to make another's day brighter.

### SUMMARY

In accordance with certain aspects of the present disclosure, a system for facilitating benefaction is provided that facilitates the donation of goods, services, money, and so forth, from a benefactor to one or more beneficiaries by informing a potential benefactor about the occurrence of one or more triggering events that may warrant donation to a particular recipient or recipients.

In accordance with certain aspects of the present disclosure, the recipient or beneficiary need not be a person. For example, the beneficiary could be a company or other organization, or a fund that supports a cause. Similarly, the benefactor of the disclosed system need not be a person. For example, the benefactor could be a company or other organization.

In accordance with further aspects of the present disclosure, the triggering event can be selected from categories of events that include, e.g., a charity category, a reward category, a social category, and a generosity category.

In accordance with further aspects of the present disclosure a triggering event is not realized until one or more conditions are met. In some examples, the conditions can relate to the location of the benefactor and/or the location(s) of the one or more beneficiaries. In some examples, the conditions can relate to shared interests between the beneficiary and the benefactor. The shared interests can be identified by, e.g., purchase behavior or social media information.

In accordance with further aspects of the present disclosure, the benefactor can identify one or more conditions to be met before being notified of a triggering event, the benefactor submitting the one or more conditions to the system.

In accordance with further aspects of the present disclosure, the identity of the beneficiary can be known or unknown to the benefactor (i.e., anonymous giving); similarly, the identity of the benefactor can be known or unknown to the beneficiary (i.e., anonymous receiving).

In accordance with further aspects of the present disclosure, a beneficiary has an option whether or not to accept a donation from the benefactor before the donation is made.

In accordance with further aspects of the present disclosure, the timing of the donation can coincide with or substantially coincide with the decision to make a donation, e.g., for a triggering event that is occurring at the same time or approximately the same time that the benefactor decides to make a donation in response to the triggering event. Alternatively, the donation can be planned (i.e., agreed to by the benefactor), but not executed until a later time, e.g., not executed until a pre-selected event occurs at some time in the future, such that the system automatically executes the donation upon the occurrence of the event without further input from the benefactor.

In accordance with further aspects of the present disclosure, the disclosed system is configured such that users of the system can provide information about themselves to the system that may be relevant to identifying conditions and triggering events that may warrant a donation from the user that provided the information, and/or a donation from another user of the system. In some examples, the users that provide information to the disclosed system can set permission parameters regarding which other users of the system are permitted to view the information, or portions of the information.

In accordance with further aspects of the present disclosure, the system is configured to identify or suggest an appropriate type of donation or types of donations for the benefactor to consider donating. In some examples, the system is configured to suggest the donation of one or more particular goods, services, or transfers of money.

In accordance with further aspects of the present disclosure, the triggering event can be associated with a user of the system who is not the actual beneficiary of the donation. Thus, for example, the beneficiary need not be a user of the disclosed system. For example, a benefactor of the disclosed system can donate money to a charity (the beneficiary) because of that charity's association (the triggering event) with another user of the disclosed system, whether or not the charity is itself a user of the system.

In accordance with further aspects of the present disclosure, the system is configured to display information to users about what has already been donated to a particular user of the system or in support of a particular user of the system. Similarly, the disclosed system is configured to display information about what users of the system have previously donated.

### DESCRIPTION OF THE DRAWINGS

FIG. 1 is a block diagram illustrating an example of a system for facilitating benefaction in accordance with aspects of the present disclosure.

FIG. 2 is a block diagram illustrating an example user device that can be used in the benefaction system of FIG. 1.

FIG. 3 is a flow diagram illustrating an example of a benefaction process implemented by the system of FIG. 1.

FIG. 4A is an example user interface display showing an example benefactor input screen or beneficiary input screen in accordance with the system of FIG. 1.

FIG. 4B is another example user interface display showing an example benefactor input screen or beneficiary input screen in accordance with the system of FIG. 1.

FIG. 4C is another example user interface display showing an example benefactor input screen or beneficiary input screen in accordance with the system of FIG. 1.

FIG. 4D is another example user interface display showing an example benefactor input screen or beneficiary input screen in accordance with the system of FIG. 1.

FIG. 4E is another example user interface display showing an example benefactor input screen or beneficiary input screen in accordance with the system of FIG. 1.

FIG. 5 is an example user interface display showing an example third party input screen in accordance with the system of FIG. 1.

FIG. 6 is a block diagram illustrating portions of an example computer system of the system for facilitating benefaction of FIG. 1.

### DETAILED DESCRIPTION

In the following Detailed Description, reference is made to the accompanying drawings, which form a part hereof, and in which is shown by way of illustration specific embodiments which may be practiced. The following detailed description, therefore, is not to be taken in a limiting sense.

Features of the system for facilitating benefaction disclosed herein can benefit each user of the system, as well as non-users of the system who become beneficiaries as a result of the system. The system can improve how people and other entities identify appropriate recipients for giving as well as streamline the actual giving process. Thus, the system can generate giving events that would not otherwise have occurred. From a broader perspective, the system can engender more charitability and giving overall, as well as help individuals in need. Features of the disclosed system can also increase awareness of others' giving, thereby improving reputations and augmenting good will associated with givers beyond traditional giving platforms.

At the same time, the dynamic nature of the disclosed system enables benefaction in response to triggering events affecting users of the system. The awareness of events that may warrant benefaction can result in transactions that would not otherwise have occurred. Thus, the various computational components involved in donating and receiving donations are improved by features and functionality of the disclosed system.

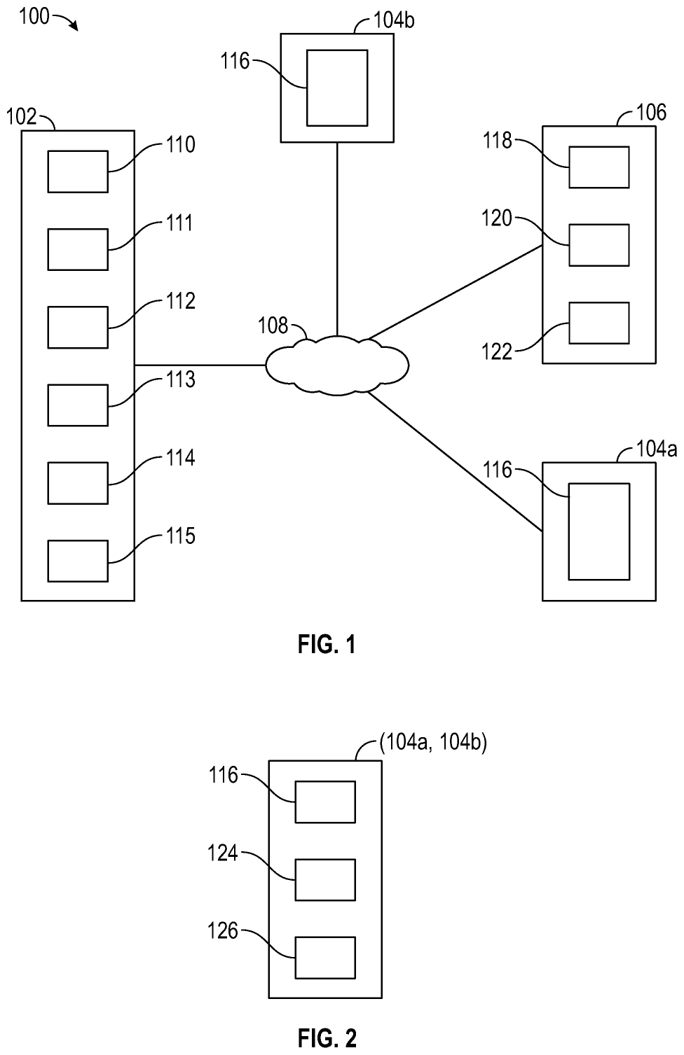

FIG. 1 is a block diagram illustrating an example of a system 100 for facilitating benefaction in accordance with aspects of the present disclosure. The system 100 includes a server 102 associated with a financial institution (“FI”), e.g., a bank, and at least two user devices (104a, 104b), each of which is associated with a user of the system 100. As used herein a user can be any person or any other entity that can be associated with a financial account. At least one of the user devices (104a, 104b) has a financial account (e.g., a credit card account, a checking account, a savings account) associated with the FI. Though not required, in this example the system 100 also includes at least one server 106 associated with a third party (“TP”), such as a merchant, an organization, a fund, a person, or so forth. The FI server 102, the user devices (104a, 104b) and the TP server 106 interact via a data communication network (“network”) 108, e.g., the Internet.

The FI server 102 can include one or more computing devices configured to operate together. The FI server includes one or more databases 110 and one or more modules containing instructions executable by a computer processor, the one or more databases being accessible to the one or more modules. The one or more modules can include, for example, a system subscription module 111, a behavior monitoring module 112, a donation condition module 113, a donation triggering module 114, and a donation execution module 115, which will be described in greater detail below. It should be appreciated that various functionalities of the benefaction facilitation system disclosed herein can be carried out by one or more of the specifically enumerated modules disclosed, or alternatively by other modules of the system that may not be explicitly disclosed but are configured to carry out the disclosed functionality. It should also be appreciated that the modules need not be executed by the FI server. For example, the system 100 can include its own dedicated server that executes the various functionality modules and that is not operated or managed by any user of the system or by any financial institution associated with the system, but that users and financial institutions may nevertheless access via the system 100.

The one or more databases 110 contain information about one or more users of the system 100. For example, the one or more databases 110 can store information about the users, such as their names, addresses, bank account information and permissions, purchase history, travel history, likes or dislikes, or so forth. In some examples, the FI server 102 alternatively or in addition is configured to access such information about one or more users of the system via the network 108 from servers and databases outside of the FI, e.g., from servers/databases associated with another financial institution or a social media network. In still further examples, as discussed above the system 100 can include its own dedicated server. Such a system-dedicated server can be linked to one or more system-dedicated databases that are not operated or managed by any user of the system 100 or by any financial institution associated with the system, but that users and financial institutions may nevertheless access via the system 100. Before access to such information can occur, in some examples the party/server/database from which the information is accessed must first give permission to the financial institution or user of the system 100 to access the information.

At least one of the user devices is associated with a user of the system 100 who has a financial account with the FI, such that funds in that user's account with the FI can be added to or subtracted from by executing features of the system 100. The user devices (104a, 104b) can be, e.g., a desktop computer, laptop computer, tablet, personal computer, smart phone, etc. that communicates over the network 108 with the FI server 102 and/or other servers associated with the system 100. In some examples, the user device (104a, 104b) also communicates over the network 108 with the TP server 106. The user device (104a, 104b) includes a user interface 116.

The user interface 116 provides an interacting platform between the user and the system 100, e.g., with the FI, the TP, or another party associated with the system 100. The user interface 116 can provide output provided by, and/or receive input required by, the system's various program modules, such as the system subscription module 111, the behavior monitoring module 112, the donation condition module 113, the donation triggering module 114, and the donation execution module 115.

The system subscription module 111 is configured to sign up users to use the system 100. Users can be benefactors, beneficiaries, as well as users that are at times benefactors and at times beneficiaries. Users can also include third parties who have products or services that can be donated between benefactors and beneficiaries of the system 100. The system subscription module 111 receives information about new users of the system 100, including, e.g., user identifying information (such as a name, address, phone number, facial photograph, email address), user preferences (such as the types of triggering events the user wants to know about, how the often the user is notified of trigger events, and the options the user has for donating receiving in response to a triggering event) and user permissions (such as settings that establish who associated with the system 100 is permitted to view certain information about the user). The system subscription module 111 can create a unique login for the user to access the system 100 from the user's device (e.g., a mobile device) and thereby access the user's account on the system 100. In addition, via the system subscription module 111, the user can link one or more of the user's financial accounts managed by the FI to the system 100, such that the system can draw funds from, and deposit funds into, the user's financial account(s) if the user gives or receives funds via the system 100. If the user links multiple financial accounts to the system 100, in some examples the system 100 is configured, prior to a donation event, to prompt the user to select the financial account or accounts from which to draw or to which to deposit the donation.

In some examples, a user of the system 100 downloads and installs a software application on a user device that electronically links the user device to the system 100, thereby enabling the user to access and process information from the system 100, as well as to enable the system 100 to access information about the user. In addition, once a user logs in to the system 100, the system 100 can access one or more of the user's financial accounts held by the FI in order to draw funds from, or deposit funds to, the financial account(s) should the user make or receive a donation via the system 100.

The behavior monitoring module 112 is configured to monitor consumer and other behavior of the users of the system 100 and pass information about users' behavior to the donation condition module 113. The behavior monitoring module 112 can use any of a variety of information sources to track a user's behavior. For example, the behavior monitoring module can track purchases on a user's financial account (e.g., a credit card account) and gather information about those purchases, as well as the user's income, net worth, etc. Other non-exhaustive examples of information sources can include a positioning device in the user's device to track the user's location and movement; a user's network-accessible calendar from which it can be determined when a user might be free for a social meeting or where a user might be on a specific day or specific time; a user's social media account(s), which can indicate the user's likes, dislikes, affiliations, occupations, schools at which the user has been a student, where the user has travelled and for what purpose (e.g., business, vacation), the identities of the user's associates (friends, families, colleagues, coworkers), and so forth.

A positioning device used in conjunction with user devices (104a, 104b) locates the user device (104a 104b), e.g., via a global positioning system, cellular tower triangulation, or other means. In some examples, the positioning device locates the user device based on the user device's connectivity to a particular Wi-Fi network, such as the Wi-Fi network available at the store of a TP user of the system 100. The proximity of a user device (104a, 104b) to a particular merchant store can be determined from the strength of that store's available Wi-Fi connection at the user device. Similarly, the location of a user device (104a, 104b) or its proximity to a particular location or object can be determined using short range communication technologies, such as Bluetooth® or near field communication. For non-mobile user devices, the positioning device can operate through other means, e.g., by identifying an IP address associated with the user device. In other examples, the location of the user device can be determined when the user logs into, e.g., a social media account.

The donation condition module 113 receives and processes user behavior information from the behavior monitoring module 112. The donation condition module 113 processes the information to generate conclusions or statistically probable conclusions about the users that form the basis of one or more donation conditions, i.e., conditions that may be relevant to a user's decision to donate via the system 100 and/or relevant to a user's desiring to be donated to via the system 100. In some examples the donation condition module 113 is configured to identify a donation condition only after a consumer behavior pattern has been determined, i.e., after a consumer event has occurred at least a predetermined threshold number of times, or at least a threshold number of times at at least a predetermined threshold frequency. For example, the donation condition module 113 could receive information from the behavior monitoring module 112 that a user of the system 100 has purchased coffee from a particular chain of coffee shops at least three times per week for four weeks. The donation condition module 113 processes that information and establishes a donation condition associated with that user, the donation condition being that user's high propensity for purchasing coffee from that coffee shop chain.

In another example, the behavior monitoring module 112 retrieves information from the social media account of a user of the system 100 indicating that the user donated money to support a particular type of cause, such as an orphanage. The behavior monitoring module 112 passes this information to the donation condition module 113. In turn, the donation condition module 113 can be configured, for example, to establish a donation condition for that user once the donation condition module 113 processes at least a predetermined threshold number of orphanage donations by that user, the donation condition being that user's high propensity for donating money to orphanages. In addition or alternatively, for example, the donation condition is not established until the user has donated at least a threshold amount of money to one or more orphanages. In still alternative examples, the donation condition can be established by a single donation from the user to an orphanage.

In another example, the behavior monitoring module 112 determines (e.g., from a social media account), that a user has lost their job, and passes this information to the donation condition module 113. The donation condition module 113 can be configured to immediately create a donation condition upon receiving information from the behavior monitoring module 112 that the user has lost their job, the donation condition being the user's job loss.

In some examples, the donation condition module 113 is configured to identify a donation condition based on isolated data points rather than, or in addition to, data patterns. Such isolated data points can include, for example, a user's current location, home address, or a piece of information posted about the user on that user's social media account. For example, the donation condition module 113 establishes a current location donation condition for a user of the system 100 when that user is inside a shop of a particular coffee chain. In another example, the donation condition module establishes a condition based on information retrieved from the social media account of the user of the system 100 indicating that the user has a particular hobby or other interest, or a particular occupation, such as a cardiologist (and therefore may be inclined to donate to another user who, e.g., has recently had a heart operation).

In some examples, the donation condition module 113 is configured to identify donation conditions based on a user's past benefaction behavior. For example, the donation condition module 113 is configured to identify donation conditions for a potential benefactor based on that user's propensity to make a particular type of donation in the past, e.g., to pay for different individuals' cups of coffee or highway tolls about once a week. In another example, the donation condition module is configured to identify donation conditions for a potential beneficiary based on that user's propensity to receive a particular type of donation in the past, e.g., to receive a cup of coffee or a highway toll from a benefactor on more than one occasion.

In still further examples, users of the system 100 can establish their own donation conditions for immediate processing by the donation condition module 113. For example, a user interested in being a beneficiary can submit a notification to the system 100 that they are having a bad day or a bad week for a specific reason or reasons (e.g., they are sick, a pet died, they lost their job, they broke up with their significant other). Similarly, a user interested in being a benefactor can a submit a notification to the system 100 that they would like to donate for a particular reason or reasons and establish one or more donation condition(s) associated with them via the donation condition module (e.g., to help someone having a bad day, or to support someone who has been very generous, or to reward someone who has donated to a particular charity or type of charity).

Regardless of how donation conditions are established, in some examples, the donation condition module 113 is configured to rank donation conditions for particular users of the system 100. For example, each donation condition is assigned a point value which can be adjusted as the system learns more information about, e.g., the user's spending, likes, friends and acquaintances, and the user's benefaction history with the system itself. For example, the condition of a user's presence at a particular restaurant may be assigned an initial point value by the system 100 that increases with each donation the user makes while at that restaurant when prompted to do so by the system, or decreases each time the user declines to make such a donation.

The donation triggering module 114 coordinates with the donation condition module 113 to identify donation triggering events that may warrant prompting a user of the system 100 to make a donation.

The donation triggering module 114 can be configured to identify a donation triggering event by, e.g., identifying donation conditions of a single user of the system 100. In some of these examples, a donation triggering event is realized when the donation conditions at a given moment combine to meet or exceed a minimum condition point threshold. For example, the system can be configured to realize a donation triggering event when the number of donation condition points for a particular user alone at a particular time exceeds twenty. Thus, in this example, that particular user's presence in a particular restaurant could have a value of fifteen points, and the condition that the user was in church on the same day could be assigned a value of ten points, e.g., because the system has learned that the user has a propensity to donate on the same day that they go to church. The combination of the fifteen points for the user's current location condition and the ten points for the user's presently pertinent past benefaction behavior of that user exceeds the twenty point threshold, establishing a donation triggering event and prompting the system to suggest that the user makes a donation while at the restaurant.

The donation triggering module 114 can also be configured to realize donation triggering events by cross-referencing donation conditions of a first user of the system 100 against donation conditions of a second user or additional users of the system 100 and identifying a match. Thus, in some examples, the system 100 generates, maintains and updates a list of donation conditions for each benefactor/beneficiary of the system 100. As discussed above, such a list could be ranked according to a point system hierarchy, with each donation condition on the list assigned an adjustable point value. The donation triggering module 114 can cross-reference the donation condition list of one user with that of another user to determine donation triggering events when one or more donation conditions of one user match one or more donation conditions of another user at a given time. By “match” is meant that the donation condition of the one user is contextually similar or related to the donation condition of the other user. For example, a first user's history of donating to orphanages, and a second user's adoption of an orphan are two donation conditions that match because they are contextually related (e.g., the user with a history of donating to orphanages may be inclined to donate money to the adoptive parent of an orphan, or vice versa).

In addition to cross-referencing donation conditions between different users for contextual matches, the donation triggering module 114 can also be configured to not realize a donation triggering event until the combination of the matched donation conditions meets or exceeds a predetermined threshold of donation condition points. For example, the system can be configured to realize a donation triggering event when the number of donation condition points, whether associated with a single user, or with multiple users whose conditions match up, exceeds twenty. In this example, a first user's presence in a particular restaurant has an assigned point value of fifteen, and a second user's presence in that particular restaurant has an assigned value of ten because, e.g., the second user and the first user both have an interest in helping orphans. The combination of the fifteen points for the first user's current location condition and the ten points for that particular second user's current location condition exceeds the twenty point threshold, establishing a donation triggering event and causing the system to suggest to one or both of the users to make a donation.

Examples of different types of donation triggering events will now be described.

In an example of a generosity-type triggering event, the donation triggering module 114 associates a first user's propensity for purchasing coffee from a particular coffee chain donation condition with the donation condition of a second user's current location in a branch of that same coffee chain, causing the system 100 to display a suggestion on the user device of the first user suggesting a donation of a coffee (or other products) from the particular coffee chain to the second user. In another example of a generosity-type triggering event, the donation triggering module 114 matches the donation condition of a first user who has recently posted on their social media account that they had a baby with a donation condition of a second user who recently posted on their social media account that their child has recently become toilet trained, the donation triggering module 114 causing the system 100 to display a suggestion on the user device of the second user suggesting a donation of diapers to the first user.

Thus, in some examples of a generosity-type triggering event, the donation condition is contextually related to the specific donation or donations suggested by the system 100.

In an example of a charitable-type triggering event, the donation triggering module 114 matches the donation condition of a first user of the system 100 who has recently lost their job with the donation condition of a second user of the system 100 who has established their condition of wanting to help someone having a hard time, causing the system 100 to display a suggestion on the user device of the second user suggesting a donation to the first user. The suggested donation can be a selectable option by the second user, and the options available may be generated by one or more donation conditions (such as a user's location and/or spending propensities).

In another example of a charitable-type triggering event, a donation condition associated with a potential benefactor of the system is the benefactor's location at a restaurant, and a contextually matched donation condition associated with potential beneficiaries of the system is the beneficiaries' location at the same restaurant at the same time. The donation triggering module 114 prompts the potential benefactor of the system 100 (or, conversely, the user prompts to the system) to make a donation (e.g., pay for a coffee or lunch) to the beneficiary currently at that restaurant who has the lowest net worth.

Thus, in some examples of a charitable-type triggering event, the donation condition can be, but need not be, contextually related to the specific donation or donations suggested by the system 100.

In an example of a reward-type triggering event, the donation triggering module 114 matches the donation condition of a first user of the system 100 who has donated more than $1,000 to orphanages in the past year with the donation condition of a second user of the system 100 who has performed volunteer work for an orphanage (as posted on social media), causing the system 100 to display a suggestion on the user device of the first and/or the second user suggesting a reward donation to the other user. The suggested donation can be a selectable option, and the options available may be generated by/contextually relate to one or more donation conditions (such as a user's location and/or purchasing propensities).

Thus, in some examples of a reward-type triggering event, the donation condition can be, but need not be, contextually related to the specific donation or donations suggested by the system 100.

In an example of a social-type triggering event, the donation triggering module 114 identifies a match between two or more potential beneficiaries of the system 100 and a potential benefactor of the system 100. For example, the donation triggering module 114 identifies a donation condition associated with a first user of the system 100, the donation condition being passed from the donation condition module 113 and indicating that the first user of the system 100 has recently started a job with a particular job title in a particular division at a particular company. The donation triggering module 114 also identifies a donation condition associated with a second user of the system 100, the donation condition being passed from the donation condition module 113 and indicating that the second user of the system 100 works at the same company and has the same job title in the same company division as the first user. In addition, the donation triggering module 114 identifies a donation condition associated with a third user of the system 100, the donation condition being passed from the donation condition module 113 and indicating that the third user of the system 100 is a manager in the same division of the same company as the first user and the second user. The donation triggering module 114 thus matches these donation conditions for the first, second and third users, and causes the system 100 to display a suggestion on the user device of the third user to make a donation that can help the first user acclimate to their new job. For example, the donation triggering module can suggest that the third user pay for the first user and the second user to get lunch together at a restaurant near their workplace. In some examples, the suggestion can even include a suggested or required day and time for the lunch based on the beneficiaries' schedules, which were accessed by the behavior monitoring module 112 and themselves established as donation conditions by the donation condition module 113, thereby causing the donation triggering module 114 to match the calendar free time donation condition of the first user and the calendar free time donation condition of the second user in generating the donation suggestion for the third user. In some examples, the restaurant (or other third party goods/services provider) suggested by the donation triggering module 114 is also a user of the system 100, such as a TP associated with a server 106 of the system 100.

In another example of a social-type triggering event, the donation triggering module 114 matches the donation condition of a first user who has recently moved to a particular neighborhood with a donation condition of a second user who lives in the same neighborhood, the donation triggering module 114 causing the system 100 to display a suggestion to the user device of the second user to make a donation to help the two users get to know each other. For example, the system 100 can suggest that the second user buys tickets for the first user and the second user to attend a sporting event together.

Once the benefactor selects one or more donations to make (e.g., donations that have been suggested to the benefactor by the system 100), the donation execution module 115 is configured to execute the selected donation, drawing the necessary funds from one or more financial accounts or digital wallet of the benefactor, and transferring them either directly to the beneficiary or beneficiaries, or to the TP that is providing the gifted good or service to the beneficiary or beneficiaries. In some examples, the donation execution module 115 issues a coupon or voucher for a product or service provided by a TP and sends (e.g., emails) the coupon or voucher to the user device of the beneficiary.

The TP server 106 can include at least one database 118 and at least one module (120, 122), the modules (120, 122) containing instructions executable by a computer processor, the one or more databases 118 being accessible to the one or more modules (120, 122). The database 118 can be, for example, a merchant database that includes information about the merchant's products, store locations, and so forth. The module 120 can be, for example, a donation processing module configured to receive a request from a benefactor of the system 100 to donate a product or service vended by the merchant. The donation processing module 120 can receive the donation request to donate a product or service provided by the merchant to a beneficiary of the system 100 and also process the transfer of the donated funds from, e.g., the benefactor's FI account to a financial account held by the TP. In some examples, the database 118 can also include instructions that, when executed by a computer processor, share information via the network 108 about the products and/or services provided by the merchant that a benefactor of the system 100 may be interested in donating.

The module 122 can be, for example, a beneficiary verification module configured to verify the identity of a beneficiary of the system 100. For example, once a donation of a product or service provided by the merchant has been completed, if the donation execution module 115 transfers the donated funds directly to the TP, the beneficiary of the system 100 must verify to the TP that they are the recipient of the donation. The beneficiary verification module 122 can be configured to process identity-related information associated with the beneficiary (e.g., a photograph, fingerprint, signature, membership number, password, etc.) to verify the beneficiary's entitlement to the donated good or service.

In some examples, the donation triggering module 114 identifies multiple potential user-beneficiaries in conjunction with a single donation triggering event. The donation condition of a benefactor's location in a coffee shop could match one or more donation conditions of two or more different potential beneficiaries. For example, each of the two or more beneficiaries can have a matching donation condition by being in the same coffee shop as the benefactor at the same time as the benefactor. However, in some examples, the donation triggering module 114 is configured to prioritize the two or more beneficiaries by suggesting to the benefactor a donation to just a subset of the two or more beneficiaries and/or by ranking the potential beneficiaries according to one or more criteria. Such criteria could include any parameters that could implicate the potential benefactor's desire to donate to the particular beneficiary, the potential beneficiary's willingness to receive a donation, and/or the beneficiary's worthiness to receive a donation. For example, the donation triggering module 114 can rank a potential beneficiary who has made more donations (in number or total dollar quantity) via the system 100 above a potential beneficiary who has made relatively fewer donations via the system 100. In another example, the donation triggering module could rank a potential beneficiary lower than another due to some social/societal demerit attached to the potential beneficiary for e.g., failing to make mortgage payments or for being uncharitable. In extreme cases of unmeritorious behavior, the system can effectively lock a user out from receiving donations. In other examples, users that publicize their own misfortunes or challenges to the system, (e.g., loss of a job, breaking up with a significant other, death of a pet, birth of a baby) can be ranked relatively high by the donation triggering module 114.

It should be appreciated that the benefactor can be presented with one or more potential beneficiaries in a variety of different display options. For example, the benefactor can be presented with just the beneficiary that was ranked highest by the donation triggering module 114 in response to the donation triggering event. In other examples, the benefactor device can display a ranked or unranked list of beneficiaries, or even a live feed of beneficiaries.

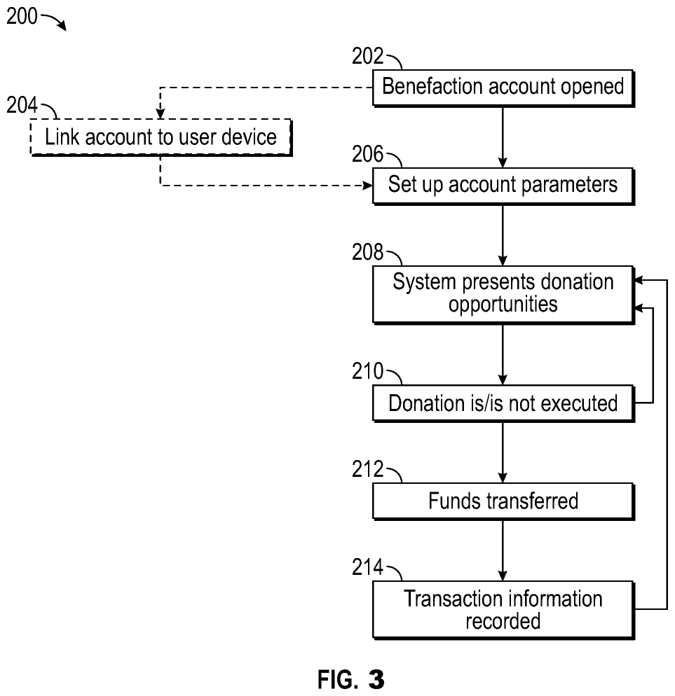

FIG. 2 is a block diagram illustrating more details of the example user device (104a, 104b) that can be used in the system 100 of FIG. 1. In the example, the user device (104a, 104b) includes the user interface 116 as described above. In this example, the user device (104a, 104b) includes an input device 124 and a positioning device 126.

The input device 124 allows the user to input information or instructions. For example, the input device 124 can be a touch user interface display screen, a voice command interface, a keyboard, a mouse, or another type of input device.

The positioning device 126 locates the user device (104a, 104b) as described above, e.g., via a global positioning system, cellular tower triangulation, or other means such as based on the user device's connectivity to a particular Wi-Fi network or via near field communication. In some examples, the proximity of a user device (104a, 104b) to a particular TP merchant store can be determined from the strength of that store's available Wi-Fi connection at the user device 104.

The user device (104a, 104b) can be configured to transmit location information about the user device via the network 108 to the server/FI server 102 and/or the TP server 106. The server/FI server 102 and the TP server 106 can be configured to process location information about the user device (104a, 104b) in identifying donation conditions and donation triggering events as discussed above, and then send benefaction-related information and/or executable options to the user device 104a/104b tailored to the user device's location. For example, the system/FI system 102 can be configured to send benefaction-related information and/or executable options to the user device (104a, 104b) when the user device reaches a predetermined minimum physical proximity to a TP merchant, as communicated by the positioning device 126.

In some examples, one or more features of the system 100 become available only when enabled by the individual user of the system 100. For example, a user may have to open and/or login to a system account residing on the database 110 or to a particular software application residing on the user device (104a, 104b) in order for the server/FI server 102 and/or the TP server 106 to interact with the user device.

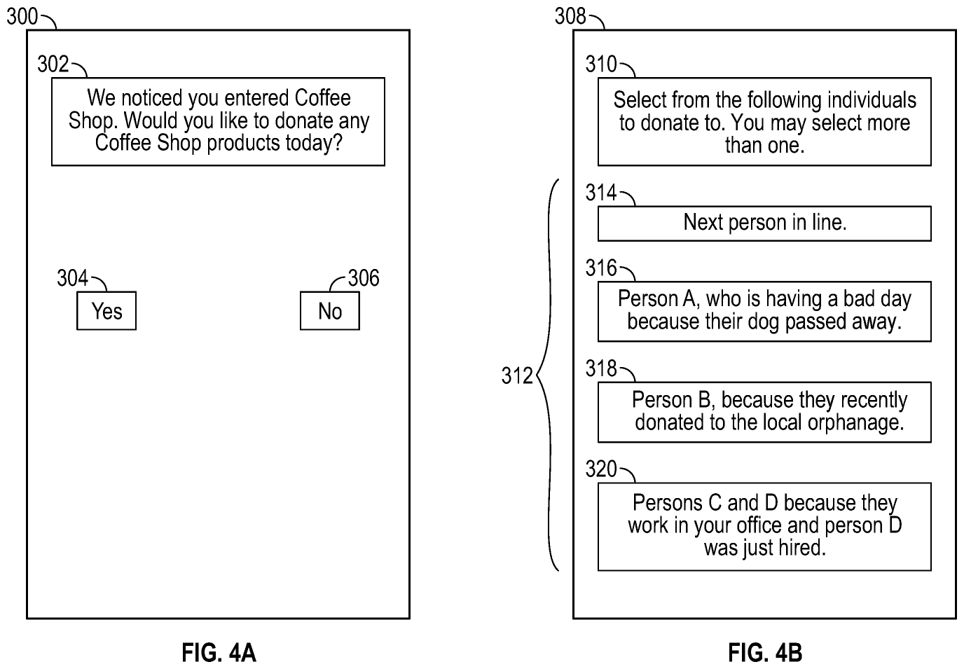

FIG. 3 is a flow diagram illustrating an example of a benefaction process 200 implemented by the system 100 of FIG. 1.

In a step 202, a user opens a benefaction account linked to a financial institution FI. In opening the account, the user provides information about the user, such as the name and contact information, income information, etc. Authentication credentials, e.g., a login name and password, security questions, etc., can be established to mitigate the chances of unauthorized access to the user account. The user account is linked to at least one financial account of the user (e.g., a credit card account or bank account). The financial account can be provided by the FI.

In an optional step 204, the user downloads and installs a software application on a user device that electronically links the user device to the benefaction account, thereby enabling the user to access the benefaction account for various purposes, such as to make or receive donations, to change settings, permissions, or other preferences, to view the user's history of giving and receiving via the system 100, and/or to submit information to the system (e.g., about the user's personal life) that may correlate with donation conditions and potentially establish donation triggering events with other users of the system 100.

In a step 206, the user can set up various account parameters, such as account permissions, settings, preferences, and links to other online accounts belonging to the user, such as social media accounts. In the step 206, the user can, for example, set information sharing permissions regarding what information will be available to other users of the system 100. The permissions can vary. For example, the user can permit sharing of certain information about the user with other users of the system 100 who are also identified as friends of the user on one or more social media networks that are linked into the system 100, while permitting sharing of just a subset of that information with other users of the system 100 who are not social media friends.

In the step 206, the user can also set what information about the user can be accessed, monitored, and used by the system 100 (even if not shared with other users of the system 100) for establishing donation conditions and donation triggering events involving the user. For example, the user can set permissions that allow the system to use information about the user's location, information about the user's spending behavior, information identifying the user's friends on social media accounts, and information from the user's posts on one or more social media accounts, but not information about the user's income, bank balance, or home address.

In the step 206, the user can also establish settings relevant to how the system 100 determines a donation triggering event for that user and when the system 100 notifies the user of a donation triggering event. For example, the user can select that they be notified about a donation opportunity only when one or more conditions are met, such as only when the potential beneficiary is at the same location as the user, or only when the potential beneficiary is someone who has donated more than they have received via the system 100, or only when the potential beneficiary works for the same company as the user or went to the same university as the user, or only following a request from the user to the system to be notified about current donation opportunities. Similarly, the user can select to be notified about only certain categories of donation opportunities, such as only charitable donation opportunities, for example, or only social donation opportunities.

In the step 206, the user can also set display preferences. For example, the user can select that donation opportunities be displayed as a continuous feed or one at a time. The user can also select preferences regarding the form of donations given and received by the user via the system 100. For example, the user can select to give or receive donations only in the form of money transfers, or only in the form of food or beverage, or only in the form of charitable donations to a third party cause.

In a step 208, the system 100 presents one or more users of the system 100 with one or more donation opportunities. The donation opportunities can be presented on the user interface 116 of the user device (104a, 104b). The system 100 identifies donation opportunities and determines which opportunities to present and when to present them in accordance with the disclosures above regarding behavior monitoring, donation conditions, and donation triggering events, as well as the account parameters set by the user from the step 206.

In a step 210, a donation from one user of the system 100 to another user of the system 100 is or is not performed. If a donation is not executed (i.e., a user declines to execute any of the donations presented by the system in the step 208), the flow then returns to the step 208 for presentation of further donation opportunities by the system 100 in accordance with the disclosures above. If a donation is executed (i.e., a user executes one or more donations presented by the system in the step 208), in a step 212 funds are transferred from a financial account of the benefactor to a financial account of the beneficiary or to a third party provider of the good/service being donated to the beneficiary, and in a step 214, the system records information about the transaction that it can use in determining future donation opportunities that may be relevant to the benefactor and/or the beneficiary. The flow then returns to the step 208 for presentation of further donation opportunities by the system 100 in accordance with the disclosures above.

Thus, as described above in connection with the point systems that can be assigned donation conditions, the system 100 can be configured to modify/adapt, add and/or remove donation conditions associated with individual users of the system 100 based on that user's donation history. For example, if a user has been prompted by the system to make a donation ten separate times upon their entry into a particular restaurant and that user has declined each time to make a donation, the system can learn from the user's behavior pattern and remove entry into that restaurant as a donation condition or reduce the point value of that condition. Conversely, if, for example, a user enters a restaurant and is prompted by the system 100 to make a donation based on a combination of four different donation conditions underlying the donation triggering event, just one of which conditions is the user's presence in that restaurant, and the user agrees to make a donation, the system can learn from that donation event and assign more points to the donation condition of that user's presence in that restaurant such that, for example, only one or two other donation conditions are required to be met the next time the user is at the restaurant in order to establish a donation triggering event.

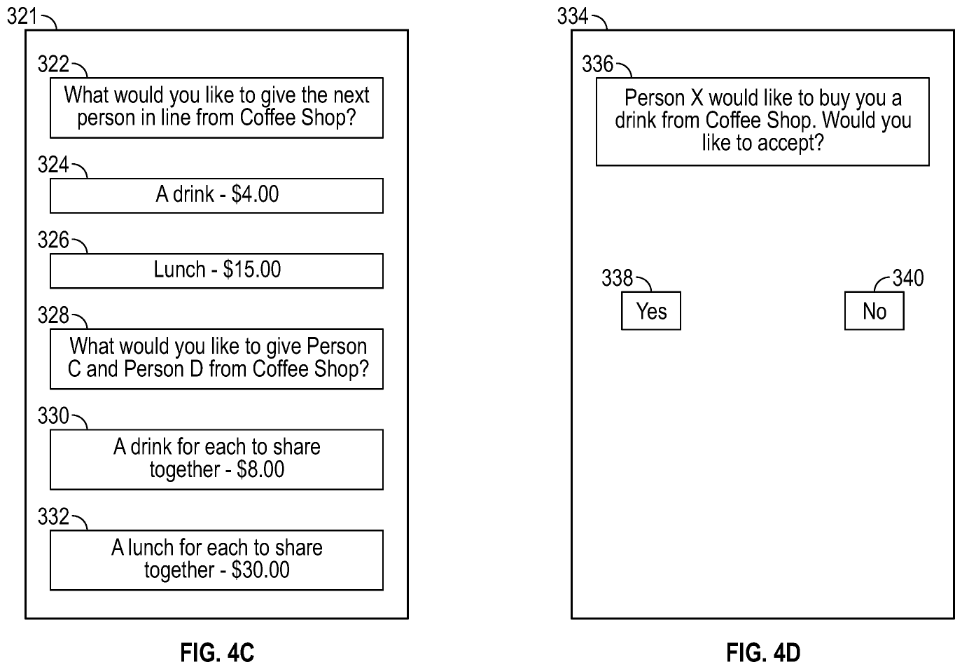

FIGS. 4A-4E are example user interface displays showing user input screens on the user interface 116 of the user device (104a, 104b) of FIG. 1. These user interface displays can be displayed to the user on the user device in conjunction with the process 200 described above. In some examples, these displays are generated when the process 200 utilizes the steps 208 and 210. Thus, the user interface displays of FIGS. 4A-4E can be implemented following the occurrence of a donation triggering event.

In FIG. 4A the user interface display 300 includes a notification 302 that informs or suggests to the user that a donation triggering event has occurred. In this example, the donation triggering event occurs at least in part because the user has entered Coffee Shop. It should be appreciated, however, that additional donation conditions in conjunction with the user's entry into Coffee Shop could have been required to have occurred to establish the donation triggering event necessary to prompt the notification 302. In this example, the notification 302 also asks the user if they would like to make a donation. In addition, because the donation triggering event in this case was at least partially the result of the user's presence in Coffee Shop, the form of the donation suggested by the system is donation of a product offered by Coffee Shop. It should be appreciated, however, that in other examples the form of donation suggested by the system 100 can be more open ended at this stage of the process, and the user can be prompted later on to select the form of donation. Moreover, in some examples, the form of donation suggested may not be contextually related in any way to the underlying donation conditions that created the donation triggering event. For example, a user who has entered Coffee Shop could be asked by the system 100 if they would like to donate money to an orphanage.

Displayed with the notification 302 are selectable options 304 and 306 (e.g., clickable “Yes” and “No” buttons) by which the user can agree to make a donation or decline to make a donation.

If the user agrees to make a donation, FIG. 4B illustrates a subsequent example user interface display 308 which includes a prompt 310 asking the user to select one or more individuals to donate to. The interface display 308 also includes a list 312 of selectable individuals to donate to. In this example, the system is configured, for some or all of the suggested beneficiaries, to provide a possible reason why the user may want to donate to them. The suggested beneficiaries can include charitable beneficiaries, generosity beneficiaries, reward beneficiaries, and/or social beneficiaries in accordance with the specific donation conditions at play, as well as the user's pre-set preferences. The suggested beneficiaries can be listed randomly. Alternatively, the suggested beneficiaries can be listed in a particular order. For example, the beneficiaries could be listed in decreasing order of the sum of: the donation condition points for that beneficiary plus the points for the matching conditions of the benefactor.

In the example in FIG. 4B, the suggested donations include a generosity donation 314 to the next person in line at Coffee Shop; a generosity donation 316 to a person at the coffee shop who has informed the user via the system 100 that they are having a bad day because their dog passed away; a reward donation 318 to the person at Coffee Shop who has donated to a charity that the user has also donated to; and a social donation 320 to two individuals who are both friends of the user and work near Coffee Shop. The user can select one or more of the beneficiaries. Alternatively, in some examples, the user is presented with an option not to donate after all, and/or to view another list of possible beneficiaries.

In FIG. 4C, an example user interface display 321 illustrates an example of what the user device can present to the user after the user selected to donate to the next person in line and Persons C and D from FIG. 4B. Prompts 322 and 328 invite the user to select from different donation options 324, 326, 330, and 332 for each of the beneficiaries. In this example, the donation options are products provided by Coffee Shop, and the options indicate the monetary value of each product donation. It should be appreciated, however, that the actual donation value could be determined at a later time, such as when the persons C and D conclude their lunch at Coffee Shop.

FIG. 4D is an example user interface display 334 illustrating what the user device of the “next person in line” at Coffee Shop can present to that beneficiary after the benefactor selects the option 324 in FIG. 4C to donate a drink to the next person in line at Coffee Shop. In this example, the user interface display 334 includes a notification 336 that Person X (the benefactor) would like to purchase a drink for the beneficiary from Coffee Shop, and invites the beneficiary to accept or decline the gift via the option buttons 338 and 340. If the beneficiary declines the gift, no funds are transferred out of the benefactor's financial account and the system 100 can, for example, inform the benefactor that the gift was declined and that no funds have been withdrawn. If the beneficiary accepts the gift, the system 100 can perform the transfer of the necessary funds from the financial account of the benefactor (Person X) to the beneficiary, e.g., in the form of a coupon, or to Coffee Shop.

FIG. 4E is an example user interface display 341 illustrating what the user device of the social beneficiary Person C can present to that beneficiary after the benefactor selects the option 332 in FIG. 4C to donate a lunch for Person C to share with Person D at Coffee Shop. In some examples a similar user interface display can displayed to a user device of Person D. In this example, the user interface display 341 includes a notification 342 that Person X (the benefactor) would like to purchase lunch for the beneficiary to share with Person D at Coffee Shop, and invites the beneficiary to accept or decline the gift via the option buttons 344 and 346. If the beneficiary declines the gift, no funds are transferred out of the benefactor's (Person X) financial account and the system 100 can, for example, inform the benefactor that the gift was declined and that no funds have been withdrawn. If the beneficiary accepts the gift (and, in some examples, if the co-beneficiary (Person D) also accepts the gift), the system 100 can perform the transfer of the necessary funds from the financial account of the benefactor (Person X) to the beneficiary, e.g., in the form of a coupon, or to Coffee Shop.

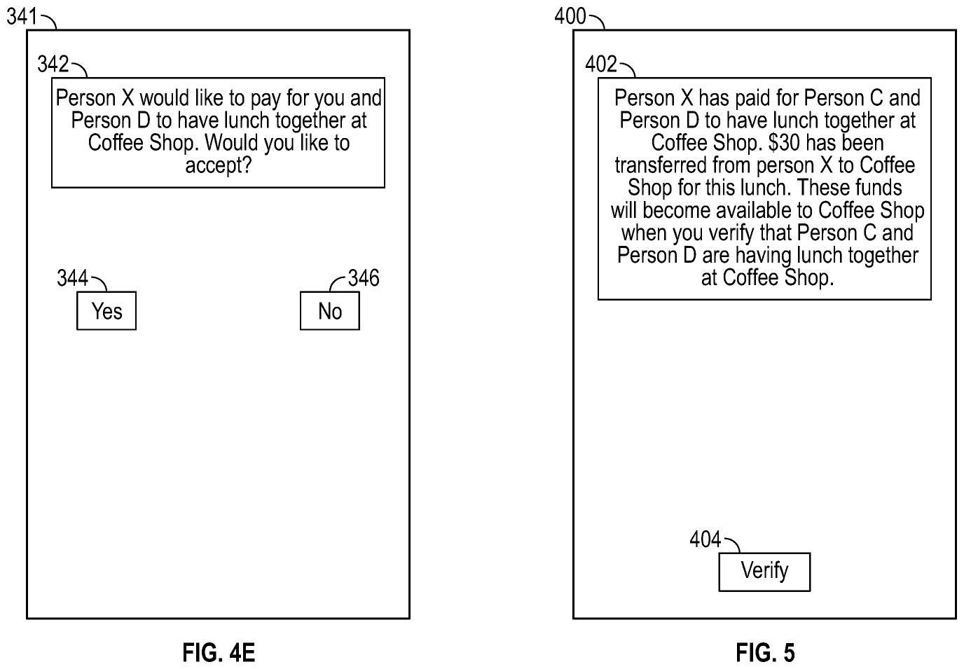

FIG. 5 is an example user interface display 400 illustrating what the user device of a TP can present to that TP after a benefactor has made a gift and a beneficiary has received that gift, particularly in the case where the funds for the donation are to be transferred to the TP (rather than to a beneficiary). In this particular example, the user interface display 400 is generated in response to the social beneficiaries' (Persons C and D) acceptance of the benefactor's gift of a lunch at Coffee Shop. The user interface display 400 includes a notification 402 to the TP that a benefactor of the system (Person X) has donated a lunch at Coffee Shop to persons C and D, and informs Coffee Shop that the funds for the lunch will be transferred to Coffee Shop once Coffee Shop confirms that the lunch between Persons C and D has taken place. In addition, in this example, a button 404 is provided on the user interface display 400. The button 404 is selectable by the TP to verify that the lunch between Persons C and D has taken place, thereby initiating the funds transfer. It should be appreciated that such a verification process can include additional requirements and/or assist Coffee Shop in identifying Persons C and D, e.g., by providing their names and photographs of their faces.

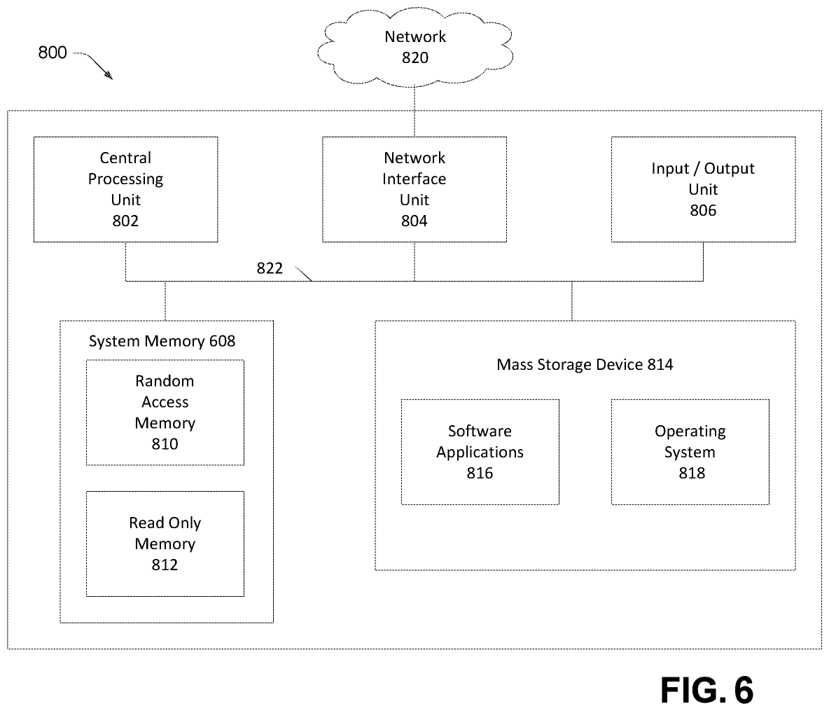

FIG. 6 schematically illustrates an example computer system 800 suitable for implementing aspects of the system 100 illustrated in FIG. 1, such as the server/FI server 102, the TP server 106, and/or the user device(s) (104a, 104b). The modules, databases, and other components of these servers and devices could all be implemented on a common computer system, or the various components could be implemented on one or more separate computer systems that are accessible by one another. The computer 800, which may be a server computer, for example, includes at least one central processing unit (“CPU”) 802, a system memory 808, and a system bus 822 that couples the system memory 808 to the CPU 802. The system memory 808 includes a random access memory (“RAM”) 810 and a read-only memory (“ROM”) 812. A basic input/output system that contains the basic routines that help to transfer information between elements within the server computer 800, such as during startup, is stored in the ROM 812. The computer 800 further includes a mass storage device 814. The mass storage device 814 is able to store software instructions and data. One or more of the databases (110, 118) could be implemented by the mass storage device 814, or one or more of the databases could be implemented by other computer systems accessible by the computer 800.

The mass storage device 814 is connected to the CPU 802 through a mass storage controller (not shown) connected to the system bus 822. The mass storage device 814 and its associated computer-readable data storage media provide non-volatile, non-transitory storage for the server computer 800. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, digital versatile discs (“DVDs”), other optical storage media, magnetic cassettes, magnetic tape, magnetic disk storage or other magnetic storage devices, or any other medium which can be used to store the desired information and which can be accessed by the server computer 800.

According to various embodiments, the server computer 800 may operate in a networked environment using logical connections to remote network devices (such as the others of the server/FI server 102, the user device (104a, 104b), and the TP server 106) through the network 820, such as a wireless network, the Internet, or another type of network. The server computer 800 may connect to the network 820 through a network interface unit 804 connected to the system bus 822. It should be appreciated that the network interface unit 804 may also be utilized to connect to other types of networks and remote computing systems. The server computer 800 also includes an input/output controller 806 for receiving and processing input from a number of other devices, including the user interface 116 generated on the user device (104a, 104b), which could include a touch user interface display screen, or another type of input device. Similarly, the input/output controller 806 may provide output to a touch user interface display screen or other type of output device.

As mentioned briefly above, the mass storage device 814 and the RAM 810 of the server computer 800 can store software instructions and data. The software instructions include an operating system 818 suitable for controlling the operation of the server computer 800. The mass storage device 814 and/or the RAM 810 also store software instructions, that when executed by the CPU 802, cause the server computer 800 to provide the functionality of the server computer 800 discussed in this document. For example, when the server computer 800 corresponds to the server/FI server 102, the mass storage device 814 and/or the RAM 810 can store software instructions that, when executed by the CPU 802, cause the server computer 800 to implement the system subscription module 111, the behavior monitoring module 112, the donation condition module 113, the donation triggering module 114, the donation execution module 115, and any other modules incorporated to perform the various functionalities described.

Although various embodiments are described herein, those of ordinary skill in the art will understand that many modifications may be made thereto within the scope of the present disclosure. Accordingly, it is not intended that the scope of the disclosure in any way be limited by the examples provided.

1. A system for facilitating benefaction, comprising:
at least one processor; and
memory encoding instructions that, when executed by the at least one processor, causes the at least one processor to:
monitor, using a plurality of electronic user devices each associated with one of a plurality of users, a spending behavior and a location of each of the plurality of users of the system, the location of each being monitored using positioning devices of the plurality of electronic user devices;
receive a donation type preference of a first of the plurality of users, the donation type preference being selected from a plurality of donation types, with a first of the plurality of donation types being based on a net worth of at least one other of the plurality of users, and with a second of the plurality of donation types being based on a previous donation by at least one other of the plurality of users;
detect locations of at least the first, a second, and a third of the plurality of users using the positioning devices of the corresponding electronic user devices of the first, second and third users, the second and third users each being unknown to the first user and the first user being unknown to each of the second and third users;
determine that the detected locations of the first, second, and third users are at a same merchant store and that each of the second and third users satisfies the donation type associated with the received donation type preference, causing a display interface of a first electronic user device of the first user to prompt the first user regarding a donation opportunity associated with the merchant store;
for each of the first, second and third users, generate a plurality of donation conditions, each of the plurality of donation conditions being associated with a donation context;
generate, with the plurality of donation conditions of the first of the plurality of users, a first list of first donation conditions each having a rank;
generate, with the plurality of donation conditions of the second of the plurality of users, a second list of second donation conditions each having a rank;
generate, with the plurality of donation conditions of the third of the plurality of users, a third list of third donation conditions each having a rank;
cross-reference the first list of first donation conditions against the second list of second donation conditions based on the donation contexts and the ranks of each of the first and second users;
cross-reference the first list of first donation conditions against the third list of third donation conditions based on the donation contexts and the ranks of each of the first and third users;
determine a first donation triggering event based on the detected locations of each of the first and second users, the received donation type preference, and the cross-reference of the first list against the second list;
determine a second donation triggering event based on the detected locations of each of the first and third users, the received donation type preference, and the cross-reference of the first list against the third list;
rank the first and second donation triggering events by comparing the cross-reference of the first list against the second list and the cross-reference of the first list against the third list, wherein the determinations of the first and second donation triggering events cause the display interface of the electronic user device of the first of the users to display, in an order, a first donation option for a good or service of the merchant store from the first user to the second user and a second donation option for a good or service of the merchant store from the first user to the third user, the order being based on the rank, the displayed first donation option including a first reason to donate to the first user, the displayed second donation option including a second reason to donate to the second user, the first and second reasons being different;
in response to a donation selection, using the user interface of the electronic user device of the first user, of at least one of the first donation option and the second donation option, execute at least one donation from a financial account of the first of the users;
remove a donation condition from the first list of donation conditions in response to a first monitored donation activity history of the first user, the first donation activity history including non-selection by the first user, and non-execution, of a prior suggested donation; and
add a donation condition to the first list of donation conditions in response to a second monitored donation history of the first user, the second monitored donation history including selection by the first user, and execution of, a prior suggested donation.

2. The system of claim 1, wherein the donation is transferred from the financial account of the first of the users to the second of the users.

3. The system of claim 1, wherein the donation is transferred from the financial account of the first of the users to a third party, the donation paying for provision of a product or service of the third party to the second of the users.

4-7. (canceled)

8. The system of claim 1, wherein the donation is executed to be shared by the second and the third of the users.

9. The system of claim 8, wherein the donation is transferred from the first of the users to a third party, and wherein the donation pays for the third party to provide one or more products or services that are shared between the second and the third of the users.

10. The system of claim 1, wherein the memory encoding instructions executed by the at least one processor causes the at least one processor to enable the second of the users to accept or decline the executed donation.

11. The system of claim 1, wherein each of the donation conditions is assigned a point value, wherein the point value of at least one donation condition for the first of the users is adjusted in response to the donation selection of the first of the users, and wherein the donation selection informs the monitored spending behavior of the first of the users.

12. The system of claim 11, wherein the first donation triggering event is identified when the cross-reference of the first and second lists of donation conditions identifies one or more donation conditions having point values, and wherein the sum of the point values exceeds a predetermined threshold for establishing the first donation triggering event.

13. A computer implemented method, comprising:
monitoring, using a plurality of electronic user devices each associated with one of a plurality of users, a spending behavior and a location of each of the plurality of users, the location of each being monitored using positioning devices of the plurality of electronic user devices;
receiving a donation type preference of a first of the plurality of users, the donation type preference being selected from a plurality of donation types, with a first of the plurality of donation types being based on a net worth of at least one other of the plurality of users, and with a second of the plurality of donation types being based on a previous donation by at least one other of the plurality of users;
detecting locations of at least the first, a second, and a third of the plurality of users using the positioning devices of the corresponding electronic user devices of the first, second and third users, the second and third users each being unknown to the first user and the first user being unknown to each of the second and third users;
determining that the detected locations of the first, second, and third users are at a same merchant store, and that each of the second and third users satisfies the donation type associated with the received donation type preference, causing a display interface of a first electronic user device of the first user to prompt the first user regarding a donation opportunity associated with the merchant store;
for each of at least the first, second and third users, generating a plurality of donation conditions, each of the plurality of donation conditions being associated with a donation context;
generating, with the plurality of donation conditions of the first of the plurality of users, a first list of first donation conditions each having a rank;
generating, with the plurality of donation conditions of the second of the plurality of users, a second list of second donation conditions each having a rank;
generating, with the plurality of donation conditions of the third of the plurality of users, a third list of third donation conditions each having a rank;
cross-referencing the first list of first donation conditions against the second list of second donation conditions based on the donation contexts and the ranks of each of the first and second users;
cross-referencing the first list of first donation conditions against the third list of third donation conditions based on the donation contexts and the ranks of each of the first and third users;
determining a first donation triggering event based on the detected locations of each of the first and second users, the received donation type preference, and the cross-reference of the first list against the second list;
determining a second donation triggering event based on the detected locations of each of the first and third users, the received donation type preference, and the cross-reference of the first list against the third list;
ranking the first and second donation triggering events by comparing the cross-reference of the first list against the second list and the cross-reference of the first list against the third list, wherein the determinations of the first and second donation triggering events cause the display interface of the electronic user device of the first of the users to display, in an order, a first donation option for a good or service of the merchant store from the first user to the second user and a second donation option for a good or service of the merchant store from the first user to the third user, the order being based on the rank, the displayed first donation option including a first reason to donate to the first user, the displayed second donation option including a second reason to donate to the second user, the first and second reasons being different;
in response to a donation selection of the first of the users, using the user interface of the user device of the first user, of at least one of the first donation option and the second donation option, executing at least one donation from a financial account of the first of the users;
removing a donation condition from the first list of donation conditions in response to a first monitored donation activity history of the first user, the first donation activity history including non-selection by the first user, and non-execution, of a prior suggested donation; and
adding a donation condition to the first list of donation conditions in response to a second monitored donation history of the first user, the second monitored donation history including selection by the first user, and execution of, a prior suggested donation.

14-15. (canceled)

16. The method of claim 13, further comprising:
assigning a point value to each of the donation conditions; and
adjusting at least one of the point values in response to the donation selection of the first of the users, wherein the donation selection informs the monitored spending behavior of the first of the users.

17. The method of claim 16, wherein the first donation triggering event is identified when the cross-referencing of the first and second lists of donation conditions identifies one or more donation conditions having point values, and wherein the sum of the point values exceeds a predetermined threshold for establishing the first donation triggering event.

18. A non-transitory computer-readable data storage medium storing instructions that, when executed by a processor, cause the processor to:
monitor, using a plurality of electronic user devices each associated with one of a plurality of users, a spending behavior and a location of each of the plurality of users;
receive a donation type preference of a first of the plurality of users, the donation type preference being selected from a plurality of donation types, with a first of the plurality of donation types being based on a net worth of at least one other of the plurality of users, and with a second of the plurality of donation types being based on a previous donation by at least one other of the plurality of users;
detect locations of at least the first, a second, and a third of the plurality of users using positioning devices of corresponding ones of the plurality of electronic user devices of the first, second and third users, the second and third users each being unknown to the first user and the first user being unknown to each of the second and third users;
determine that the detected locations of the first, second, and third users are at a same merchant store and that each of the second and third users satisfies the donation type associated with the received donation type preference, causing a display interface of a first electronic user device of the first user to prompt the first user regarding a donation opportunity associated with the merchant store;
for each of the first, second and third users, generate a plurality of donation conditions, each of the donation conditions being associated with a donation context;
generate, with the plurality of donation conditions of the first of the plurality of users, a first list of first donation conditions each having a rank;
generate, with the plurality of donation conditions of the second of the plurality of users, a second list of second donation conditions each having a rank;
generate, with the plurality of donation conditions of the third of the plurality of users, a third list of third donation conditions each having a rank;
cross-reference the first list of first donation conditions against the second list of second donation conditions based on the donation contexts and the ranks of each of the first and second users;
cross-reference the first list of first donation conditions against the third list of third donation conditions based on the donation contexts and the ranks of each of the first and third users;
determine a first donation triggering event based on the detected locations of each of the first and second users, the received donation type preference, and the cross-reference of the first list against the second list;
determine a second donation triggering event based on the detected locations of each of the first and third users, the received donation type preference, and the cross-reference of the first list against the third list;
rank the first and second donation triggering events by comparing the cross-reference of the first list against the second list and the cross-reference of the first list against the third list, wherein the determinations of the first and second donation triggering events cause the display interface of the electronic user device of the first of the users to display, in an order, a first donation option for a good or service of the merchant store from the first user to the second user and a second donation option for a good or service of the merchant store from the first user to the third user, the order being based on the rank, the displayed first donation option including a first reason to donate to the first user, the displayed second donation option including a second reason to donate to the second user, the first and second reasons being different;
in response to a donation selection of the first of the users, using the user interface of the electronic user device of the first user, of at least one of the first donation option and the second donation option, execute at least one donation from a financial account of the first of the users;
remove a donation condition from the first list of donation conditions in response to a first monitored donation activity history of the first user, the first donation activity history including non-selection by the first user, and non-execution, of a prior suggested donation; and
add a donation condition to the first list of donation conditions in response to a second monitored donation history of the first user, the second monitored donation history including selection by the first user, and execution of, a prior suggested donation.

19. The non-transitory computer-readable data storage medium of claim 18, wherein the instructions, when executed by the processer further cause the processor to:
assign a point value to each of the donation conditions; and
adjust at least one of the point values in response to the donation selection of the first of the users, wherein the donation selection informs the monitored spending behavior of the first of the users.

20. The non-transitory computer-readable data storage medium of claim 19, wherein the first donation triggering event is identified when the cross-reference of the first and second lists of donation conditions identifies one or more donation conditions having point values, and wherein the sum of the point values exceeds a predetermined threshold for establishing the triggering event.
